(19) United States
(12) Patent Application Publication
(10) Pub. No.: US 2024/0311930 A1
(43) Pub. Date: Sep. 19, 2024

(54) SYSTEM AND METHOD FOR FACILITATING INTRODUCTIONS BETWEEN USERS

(71) Applicant: John Smith, Hermosa Beach, CA (US)

(72) Inventor: John Smith, Hermosa Beach, CA (US)

(21) Appl. No.: 18/395,589

(22) Filed: Dec. 24, 2023

Related U.S. Application Data
(60) Provisional application No. 63/490,593, filed on Mar. 16, 2023.

(51) Int. Cl. G06Q 50/00

(52) U.S. Cl. CPC G06Q 50/01

(57) ABSTRACT

The system combines real-time geolocation and social media, offering dynamic user location updates and an intuitive interface for connecting users based on proximity and shared interests. Users can search for others within a chosen geographic location, with real-time geolocation services updating user positions. The system identifies and continually updates other users' locations using automatic geolocation services. It also collects and displays social media details, including various platforms and handles. A graphical user interface (GUI) displays these details on a 3D map, with icons representing users. Interaction with these icons reveals the social media details of selected users. The search area is user-defined, centered on the user's real-time updated position, with an adjustable radius up to 3000 miles.

### CROSS-REFERENCE TO RELATED APPLICATIONS

This application claims the benefit of U.S. provisional patent application No. 63/490,593, filed on Mar. 16, 2023, the contents of which are incorporated by reference in their entirety.

### BACKGROUND

### Field of the Invention

The present invention relates generally to a location awareness system, and, in particular, to a system for the real-time mapping of nearby users where introductions are facilitated based on shared social media details.

### Scope of the Prior Art

Connecting with new people in today's world is increasingly challenging, often due to frequently missed connections and the various interaction barriers we face daily. These barriers include hurried interactions, losing potential connections due to shyness or time constraints, and missing opportunities to meet people we might want or need to know.

The specialized features of existing media platforms hinder their usefulness for users looking to meet, befriend, and network with new people, especially those nearby. For example, an Instagram user may only be presented the option to connect to other Instagram users, limiting his or her ability to connect to other users on other platforms. As a result, such platforms are becoming less relevant for these purposes. Consequently, there's a need for an improved method to identify other nearby users and facilitate connections between them.

### SUMMARY

The present disclosure satisfies the foregoing needs by providing, inter alia, a system designed to facilitate introductions between users based on geographic proximity and shared interests, as well as methods of its use. This system comprises several key components and functionalities:

Memory and Processor Integration: The system includes memory that stores executable instructions. A processing device is employed to execute these instructions.

User-Requested Geographic Search: Users can request searches for other users within a specified geographic location. This search function is facilitated by real-time geolocation services, ensuring up-to-date user positions.

Identification of Users and Real-Time Position Updates: The system identifies other users in the chosen geographic area. Positions of these users are continually updated in real-time, sourced from automatic geolocation services.

Collection and Display of Social Media Details: Social media details of other users are collected either directly from their devices or from an electronic database. These details encompass various social media outlets, platforms, and individual handles.

Graphical User Interface (GUI) Display: The system presents a GUI on an electronic display, showcasing the positions of other users in the geographic location. This interface includes a 3D map of the location, with icons representing other users. Interaction with these icons allows the first user to view the social media details of the selected other users.

User-Centered Geolocation Functionality: The geographic location for the search can be defined as a circle centered around the first user's position, which is also updated in real-time using geolocation services. The radius of this circle can be adjusted by the user, with a maximum extent of 3000 miles.

In summary, this patent describes an advanced, interactive system that leverages real-time geolocation technology and social media integration to connect users within a customizable geographic range. The system's key innovation lies in its ability to dynamically update user locations and present this information within an intuitive graphical interface, thereby enhancing the user's ability to make new connections based on proximity and shared digital platforms.

### BRIEF DESCRIPTION OF THE DRAWINGS

The foregoing summary, as well as the following detailed description of preferred variations of the invention, will be better understood when read in conjunction with the appended drawings. For the purpose of illustrating the invention, there is shown in the drawings variations that are presently preferred. It should be understood, however, that the invention is not limited to the precise arrangements shown. In the drawings, where:

FIG. 1 is a block diagram illustrating example physical components of a system with which aspects of the present disclosure may be practiced.

FIG. 2 shows a method of facilitating introductions between users, according to an embodiment.

FIGS. 3a-3g show various method steps as displayed on an electronic display.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to any single implementation or implementations. Wherever convenient, the same reference numbers will be used throughout the drawings to refer to same or like parts.

Moreover, while variations described herein are primarily discussed in the context of software that facilitates introductions between users, it will be recognized by those of ordinary skill that the present disclosure is not so limited. In fact, the principles of the present disclosure described herein may be readily applied to connect users for other purposes.

In the present specification, an implementation showing a singular component should not be considered limiting; rather, the disclosure is intended to encompass other implementations including a plurality of the same component, and vice-versa, unless explicitly stated otherwise herein. Further, the present disclosure encompasses present and future known equivalents to the components referred to herein by way of illustration.

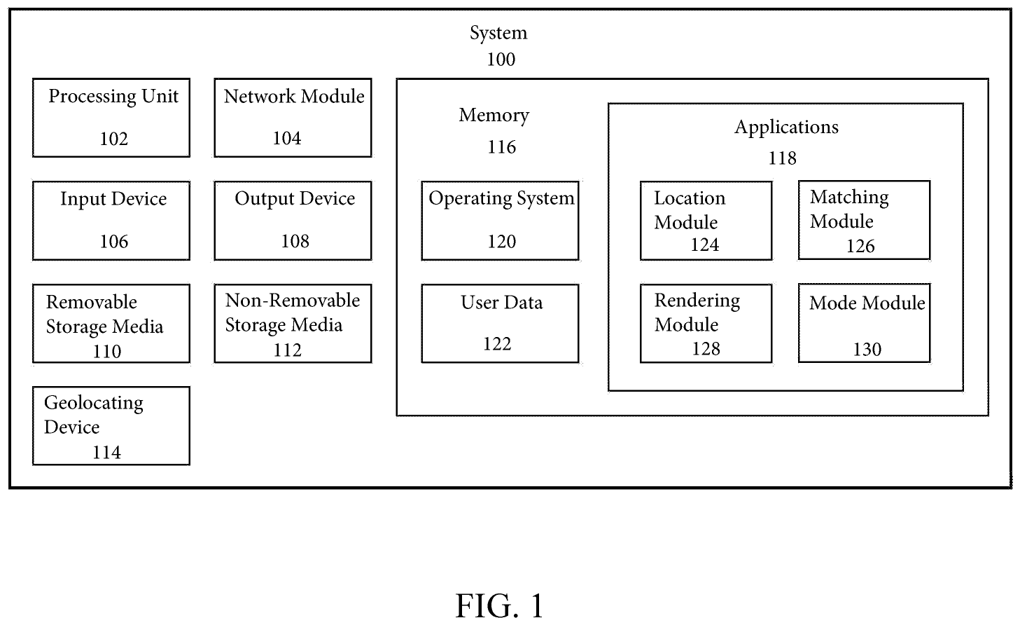

FIG. 1 is a block diagram illustrating example physical components (e.g. hardware) of the system 100. In its basic configuration, the system 100 may include at least one processing unit 102 and memory 116.

The processing unit 102 executes commands to perform the functions specified in flowcharts and/or block diagram blocks throughout this disclosure. It should be appreciated that processing may be implemented either locally via the processing unit 102 or remotely via various forms of wireless or wired networking technologies or a combination of both.

The term computer readable media as used herein may include computer storage media. Computer storage media may include volatile and nonvolatile, removable and non-removable media implemented in any method or technology for storage of information, such as computer readable instructions, data structures, or program modules. The memory 116, the removable storage device 110, and the non-removable storage device 112 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the system 100. In some embodiments, such computer storage media may be part of the system 100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Memory 116 may include various types of short and long-term memory as is known in the art. Memory 116 may be loaded with various applications 118 in the form of computer readable program instructions. These computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Applications 118 may include a location module 124, a matching module 126, a rendering module 128, and a mode module 130, as will be further discussed. Accordingly, memory 116 includes all necessary applications per each embodiment.

The location module 124 is configured to determine the instant location of a user. According to a preferred embodiment, the location module 124 determines the location of the user based on geolocation data received from a geolocating device 114 associated with the system 100. For example, if the geolocating device 114 is a GPS receiver, the location module 124 can triangulate GPS signals received from at least three satellites to determine the user's latitude, longitude, and sometimes altitude. The instant location of the user can be, continuously or periodically, saved to user data 122.

Alternative methods of determining the location of a user include, but are not limited to: cell tower triangulation where the signal strength from nearby cell towers is used to estimate one's location; Wi-Fi Positioning Systems (WPS) where the visibility of nearby Wi-Fi networks is used to approximate one's location based on the known locations of these networks (obtained from a database); and Inertial Sensors where measurements taken from accelerometers, gyroscopes, and compasses are used to track one's movement from a known starting point.

The location module 124 is further configured to determine the instant location of other nearby users. According to a preferred embodiment, the location module 124 determines the location of other nearby users based on geolocation data received from transmissions origination from devices associated with the other nearby users. The instant location of the other nearby users can be, continuously or periodically, saved to user data 122. Alternatively, the location module 124 determines the location of other nearby users when geolocation data is received from an external database that collects location data. Said external database may, continuously or periodically, collect geolocation data or location data from devices associated with other users.

The matching module 126 is configured to match a user with other users. According to a preferred embodiment, the matching module 126 algorithmically matches the user with other users based on matching criteria of the user and other users. For example, matching criteria are age, height, and education. The matching module 126 retrieves, from user data 122, age, height, and education data for a first user. The matching module 126 retrieves, from an external electronic database, age, height, and education data for other users within a geographic location preselected by the user. The user is then matched with a plurality of second users from the other users, where the age, height, and education data of the user meets the age, height, and education requirements of each of the second users and the age, height, and education data of each of the second users meets the age, height, and education requirements of the first user.

It should be appreciated that matching criteria can be as simple as common interests or as complex as using personality tests and behavioral patterns. The criteria are adjustable, allowing users to specify what they are looking for in other users.

It should be appreciated that the matching algorithms employed by the matching module 126 can range from basic similarity calculations (like finding users with shared interests) to more sophisticated machine learning models that can learn from user interactions and improve over time.

A rending module 128 is configured to render a 3D map to be displayed on an output device 108 associated with the system 100. According to a preferred embodiment, the rendering module 128 retrieves, based on the location of the user, the relevant data required for 3D mapping such as geospatial data, 3D model data, point cloud data, and image data, depending on software requirements. Preferably, the relevant data is stored on remote servers due to its large size. The network module 104 can use internet connectivity to access this data, and in some cases, cloud computing resources are used to process the data efficiently before sending it to the rendering module 128 for rendering.

The 3D map shows different entities depending on the operating mode of the system 100.

In a first operating mode, the user is “on grid,” such that his or her user data is actively being transmitted to an external electronic database or devices associated with other users.

Preferably, a primary location marker indicating the location of the user is displayed on the 3D map when the user is “on grid.” The primary location marker can take the form of a distinct symbol or icon, such as a customized user avatar. Secondary location markers indicating the location of other users are displayed on the 3D map when the user is “on grid.” The secondary location markers can take the form of a small, less prominent symbol or icon, such as a small dot. Matched location markers indicating the location of other users that have matched with the user are displayed on the 3D map when the user is “on grid.” The matching location markers can take the form of a medium-sized, somewhat prominent symbol or icon, such as an arrow or figure.

In a second operating mode, the user is “off grid,” such that his or her user data is not being transmitted to an external electronic database or devices associated with other users.

Preferably, only a primary location marker indicating the location of the user is displayed on the 3D map when the user is “on grid.” The primary location marker can take the form of a distinct symbol or icon, such as a customized user avatar.

The mode module 130 is configured to track the operating mode of the system 100. The operating mode of the system 100 is adjustable by the user.

Memory 116 may also include an operating system 120 and user data 122 as will be further discussed. In certain embodiments, memory 116 may be implemented locally, whereas in other embodiments, memory 116 may be implemented remotely.

The operating system 114 is suitable for controlling the operation of the system 100.

User data 122 The is configured to store profile data for a user. According to a preferred embodiment, user data 122 includes: matching criteria data for the user, such as his or her age, height, and education; matching requirements the user, such as his or her age requirement, height requirement, and education requirement; geographic location of the user, such as the instant location of the user; search radius or other search boundaries, such as the scope of the area around the geographic location in which the user wants to meet other users; and social media details for the user such as his or her social media outlets, social media platforms, and social media handles.

The system 100 may further comprise a network module 104, an input device 106, and output device 108, and a geolocating device 114.

The network module 104 is configured to enable network connectivity among the system 100, the devices of other users, and electronic databases storing user data associated with the user or other users. Network connectivity may be achieved through the use of common telecommunication infrastructure such as routers, switches, and gateways. Alternatively, network members may communicate according to conventional wireless communication standards including, but not limited to, Bluetooth.

The input device 106 is configured to enable user interaction with the system 100. Preferably, the input device 106 is a touchscreen or keypad. Alternatively, the input device 106 may be a smart phone or other electronic devices in communication with the system 100. Yet alternatively, the input device 106 may be a microphone for speech capture, a camera for visual text or motion capture, a keyboard, buttons, or any other device or method of receiving instructions.

The output device 108 is configured to enable system 100 interaction with the user. Preferably, the output device 108 may be a display screen in any of the various forms associated with smart devices. Alternatively, the output device 108 may be a speaker, acoustic generator, or any other device or method of transmitting updates or data.

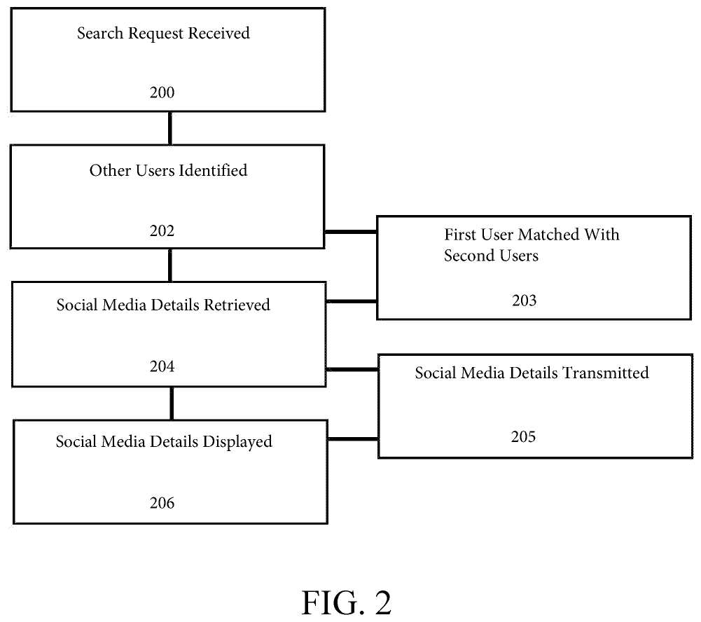

FIG. 2 shows a method of facilitating introductions between users, according to an embodiment.

The method may begin step 200 in which a request to conduct a search for other users near a geographic location is received from a device associated with a first user. According to a preferred embodiment, the geographic location is pre-selected by the first user. Alternatively, the geographic location is area near the instant location of the first user as determined by the location module 124.

Upon receiving the request, the system 100 retrieves, from user data 122, the instant location of the user, the geographic location for the search, and the social media details for the user. In some embodiments, the system 100 further retrieves, from user data 122, matching criteria data and matching requirements.

The system 100 then retrieves, from an external electronic database, the instant locations and social media details of other users. In some embodiments, the system 100 further retrieves, from an external electronic database, matching criteria data and matching requirements for other users.

The method proceeds to step 202 in which the other users in a geographic location are identified. According to a preferred embodiment, the positions of the other users are updated in real-time as an output from at least one automatic geolocation service on the devices of the other users.

The method optionally proceeds to step 203 in which the first user is matched with second users from the other users in the geographic location. According to a preferred embodiment, matching may occur when the matching criteria data of the user meets the matching requirements of one of the second users and the matching criteria data of the second user meets the matching requirements of the first user.

The method proceeds to step 204 in which the social media details are retrieved for each of the other users in the geographic location or from the matched second users. According to a preferred embodiment, these social media details may be retrieved from devices associated with the second users or from an external electronic database containing the social media details for each of the second users.

The method optionally proceeds to step 205 in which the social media details of the second users are transmitted to the device associated with the first user.

The method proceeds to step 206 in which the social media details of the second users are displayed on an electronic display of the device associated with the first user. The display of social media details of a second user may occur when a first user interacts with (e.g., clicks) an icon associated with the second user.

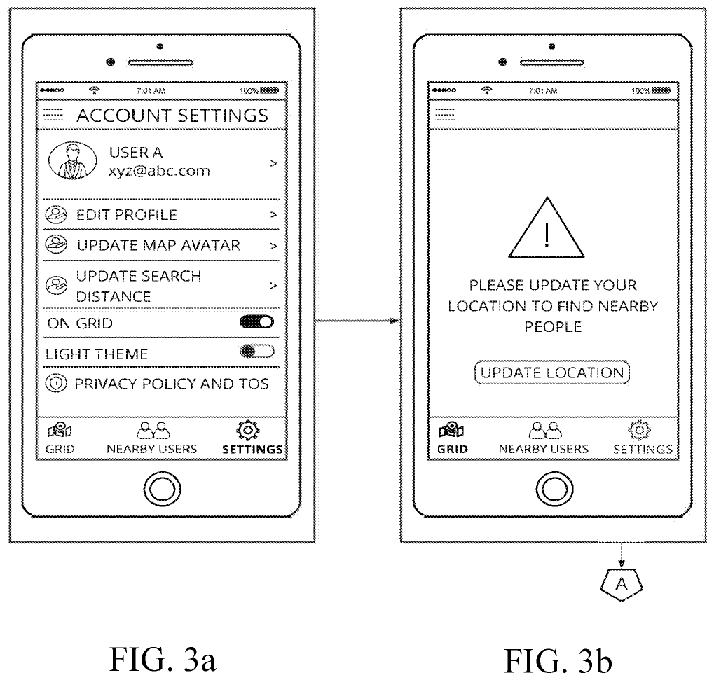

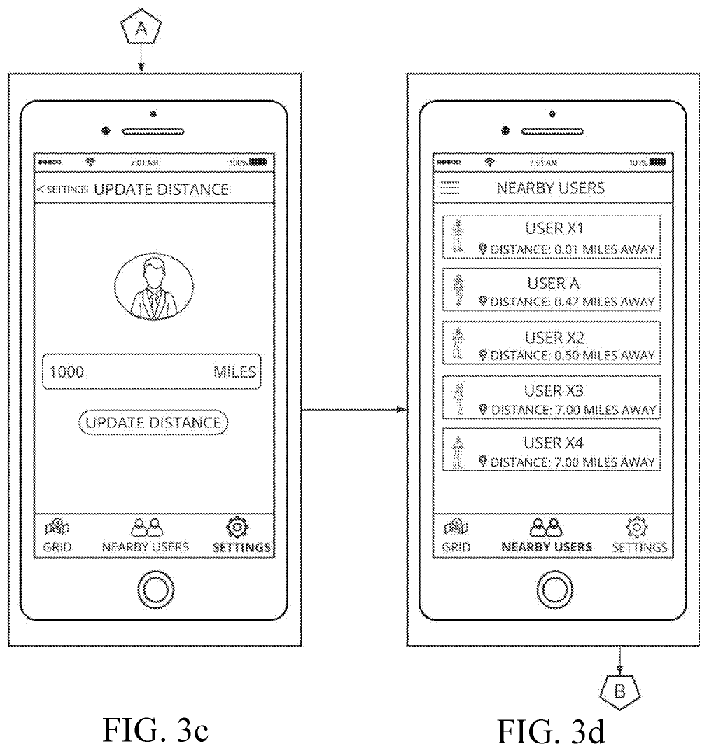

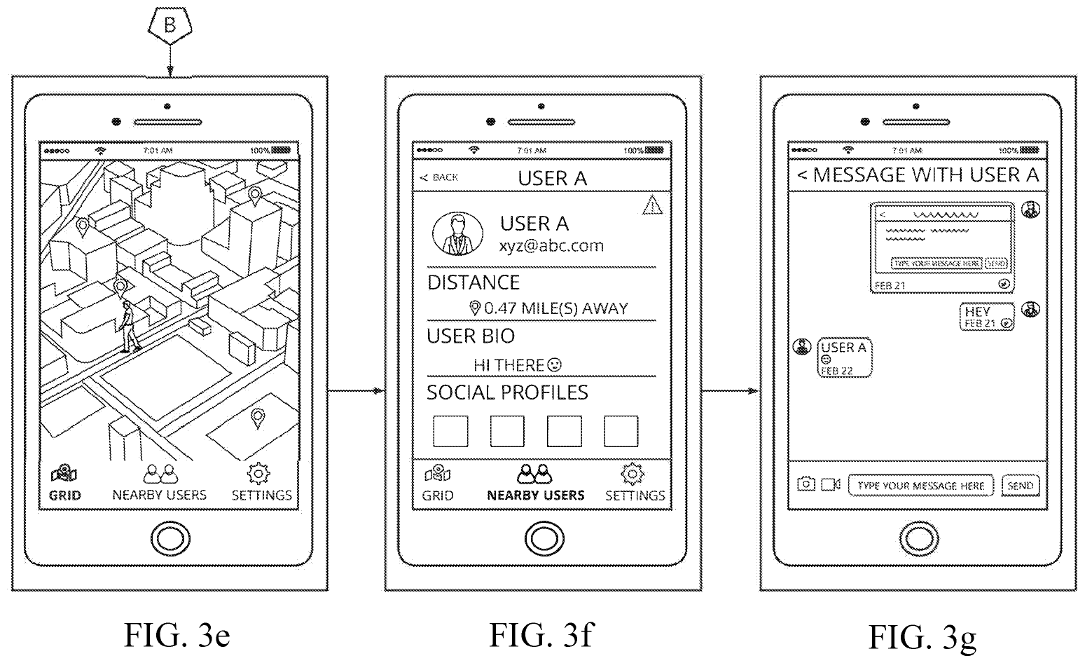

FIGS. 3a-3g show various system 100 processes as displayed on an electronic display.

FIG. 3a shows an “account settings” page in which a user can update his or her user data or adjust the functionality of the system 100. Examples of updatable user data include, but are not limited to, matching criteria data for the user; matching requirements the user; geographic location of the user; search radius or other search boundaries; and social media details for the user. Examples of adjustable functionality include, but are not limited to, the operating mode of the system 100 (e.g., “on-grid” or “off-grid”).

FIG. 3b shows a “location services” page in which the system 100, with the approval of the user, determines the instant location of the user.

FIG. 3c shows a “search settings” page in which the user can update the search radius or other search boundaries.

FIG. 3d shows a “matches” page in which matches are listed. The approximate location of the matches, or the approximate distance between the user and the matches, may be displayed.

FIG. 3e shows a “3D mapping” page in which the location of the user, the location of other users, and the location of matches, are displayed on a 3D map.

FIG. 3f shows a “details” page in which social media details of matches are presented. According to a preferred embodiment, the “details” page for a match is displayed after the user clicks the avatar of a match on the “3D mapping” page.

FIG. 3g shows a “messaging” page in which the user and the match are communicating through a messenger associated with a shared social media platform.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

I claim:

1. A computer-implemented method for facilitating introductions between users, the method comprising steps of:
receiving, from a device associated with a first user, a request to conduct a search for other users in a geographic location, the geographic location selected by the first user;
identifying, with the aid of a processor, the other users in the geographic location, wherein
positions of the other users are updated in real-time;
the positions of the other users are an output from at least one automatic geolocation service; and
receiving, from devices associated with the other users or from an electronic database in communication with the devices associated with the other user, social media details of the other users.

2. The method of claim 1, further comprising steps of:
displaying, on an electronic display, a graphic user interface, wherein
the graphic user interface includes the positions of the other users in the geographic location.

3. The method of claim 1, further comprising steps of:
displaying, on an electronic display, a graphic user interface, wherein
the graphic user interface includes:
a 3D map of the geographic location;
icons associated with the other users and displayed at the positions of the other users in the geographic location;
displaying, on the electronic display, the social media details of a given other user when the first user interacts with an icon associated with the given other user.

4. The method of claim 1, wherein
the geographic location is a circle centered at a position of the first user;
the position of the first user is updated in real-time; and
the position of the first user is an output from at least one automatic geolocation service.

5. The method of claim 4, wherein
a radius of the circle is adjustable up to 3000 miles.

6. The method of claim 1, wherein
the social media details include at least one of:
social media outlets;
social media platforms; and
social media handles.

7. A system to facilitate introductions between users, the system comprising:
memory storing executable instructions:
a processing device executing the instructions, wherein the instruction cause the processing device to:
receive, from a device associated with a first user, a request to conduct a search for other users in a geographic location, the geographic location selected by the first user;
identify, with the aid of a processor, the other users in the geographic location, wherein
positions of the other users are updated in real-time;
the positions of the other users are an output from at least one automatic geolocation service; and
receive, from devices associated with the other users or from an electronic database in communication with the devices associated with the other user, social media details of the other users, social media details of the other users.

8. The system of claim 7, wherein the instructions further cause the processing device to:
display, on an electronic display, a graphic user interface, wherein
the graphic user interface includes the positions of the other users in the geographic location.

9. The system of claim 7, wherein the instructions further cause the processing device to:
display, on an electronic display, a graphic user interface, wherein
the graphic user interface includes:
a 3D map of the geographic location;
icons associated with the other users and displayed at the positions of the other users in the geographic location;
display, on the electronic display, the social media details of a given other user when the first user interacts with an icon associated with the given other user.

10. The system of claim 7, wherein
the geographic location is a circle centered at a position of the first user;
the position of the first user is updated in real-time; and
the position of the first user is an output from at least one automatic geolocation service.

11. The system of claim 10, wherein
a radius of the circle is adjustable up to 3000 miles.

12. The method of claim 7, wherein
the social media details include at least one of:
social media outlets;
social media platforms; and
social media handles.

13. Non-transitory computer storage media storing executable instructions which when executed by a computing device cause the computing device to:
receive, from a device associated with a first user, a request to conduct a search for other users in a geographic location, the geographic location selected by the first user;
identify, with the aid of a processor, the other users in the geographic location, wherein
positions of the other users are updated in real-time;
the positions of the other users are an output from at least one automatic geolocation service; and
receive, from devices associated with the other users or from an electronic database in communication with the devices associated with the other user, social media details of the other users, social media details of the other users.

14. The non-transitory computer storage media of claim 13, wherein the instructions further cause the computing device to:
display, on an electronic display, a graphic user interface, wherein
the graphic user interface includes the positions of the other users in the geographic location.

15. The non-transitory computer storage media of claim 13, wherein the instructions further cause the computing device to:
display, on an electronic display, a graphic user interface, wherein
the graphic user interface includes:
a 3D map of the geographic location;
icons associated with the other users and displayed at the positions of the other users in the geographic location;
display, on the electronic display, the social media details of a given other user when the first user interacts with an icon associated with the given other user.

16. The non-transitory computer storage media of claim 13, wherein
the geographic location is a circle centered at a position of the first user;
the position of the first user is updated in real-time; and
the position of the first user is an output from at least one automatic geolocation service.

17. The non-transitory computer storage media of claim 16, wherein
a radius of the circle is adjustable up to 3000 miles.

18. The non-transitory computer storage media of claim 13, wherein
the social media details include at least one of:
social media outlets;
social media platforms; and
social media handles.
